(19) United States
(12) Patent Application Publication
(10) Pub. No.: US 2024/0399787 A1
(43) Pub. Date: Dec. 5, 2024

(54) V-SHAPED WHEEL SPOKE

(71) Applicant: XIAMEN X-BIKE TECHNOLOGY CO., LTD., XIAMEN (CN)

(72) Inventor: MU LI, XIAMEN (CN)

(21) Appl. No.: 18/325,096

(22) Filed: May 29, 2023

(51) Int. Cl. B60B 1/02; B60B 1/04

(52) U.S. Cl. CPC B60B 1/0276; B60B 1/042; B60B 1/048; B60B 1/003; B60B 1/041; B60B 2360/3416

(57) ABSTRACT

A V-shaped wheel spoke made of carbon fiber material is provided. The bottom part of the spoke is provided with a first through hole for placing a bolt when the spoke is connected with a wheel rim. The spoke has two legs, the top portion of each of the two legs is provided with a second through hole for placing bolt when the two legs are connected with flanges at left and right sides of a hub. With this design, the conventional connection structure consisting of spokes and nipples has been abandoned, and bolts or fastening structures are used for connection. The two legs of the spoke are respectively connected to the flanges at the left and right sides of the hub with bolts or fastening structures, such that the overall structure forms a stable triangle which greatly improves the strength and stiffness of the wheel.

### TECHNICAL FIELD

The present disclosure relates to a carbon-fiber bicycle spoke, in particular to a V-shaped wheel spoke.

### BACKGROUND

At present, wheel spokes of a bicycle or a motorcycle are generally composed of spokes and nipples. The spoke generally has a pin shape, and in some conditions may have a roughly 90-degree bend at it's head portion. The head portion of a conventional spoke has a diameter greater than the spoke body, and the end opposite to the head portion of the spoke passes through the hole on the hub flange to connect the spoke with the hub at the head portion. The opposite end of the spoke is also threaded which can pass through the spoke hole in the rim and be fastened by the nipple. By fastening the nipple, the spokes can be tensioned to the same extent to achieve the desired strength of the wheel, and the radial and axial concentricity of the wheel can be corrected. The the design of this structure is up to the characteristics of the metal material of the spokes, and this structure has the advantages of simple, reliable, low-cost and convenient maintenance, etc.

Entering the era of new material application represented by carbon fiber, due to the different mechanical properties and manufacturing processes of carbon fiber materials, the above structure is not suitable anymore. First of all, carbon fiber products consisting of carbon fiber precursor and resin are unable to take thread machining. Secondly, the mechanical characteristics of carbon fibers exhibit the largest strength along the direction of the fiber strands, and the carbon fibers are prone to fracture and break by lateral force. Additionally, the position where the spokes and the nipples are connected tends to have material fatigue fracture because angle deviation occurs when drilling holes on the rim. Moreover, even combining the carbon fiber with metal, it is difficult to take advantage of the light weight and high strength of carbon fiber materials, thus the spokes need redesign to show the strengths of carbon fiber.

### SUMMARY OF DISCLOSURE

One objective of the present disclosure is to provide a V-shaped wheel spoke which abandons the conventional hub design, and uses bolt or an fastening structure to connect the spokes instead. By doing so, it is easier to manufacture the hub with carbon fiber materials because the hub is not required to bear large tension force from the spokes.

The present disclosure provides the following solutions. A V-shaped wheel spoke, wherein a bottom part of the V-shaped wheel spoke is provided with a first through hole, the first through hole is configured to place a bolt for connecting the V-shaped wheel spoke with a wheel rim, the V-shaped wheel spoke has two legs, and each of the two legs is provided with a second through hole at a top portion of the leg, the second through holes are configured to place bolts for connecting the V-shaped wheel spoke with flanges at left and right sides of the hub.

As a further improvement, the first through hole at the bottom part of the V-shaped wheel spoke has a diameter of 5 mm, and the second through hole at the top portion of the two legs of the V-shaped wheel spoke has a diameter of 6 mm.

As a further improvement, the V-shaped wheel spoke is made of carbon fiber material.

According to another aspect of the present disclosure, a V-shaped wheel spoke is provided; wherein a bottom part of the V-shaped wheel spoke is provided with a first through hole, the first through hole is configured to place a bolt for connecting the V-shaped wheel spoke with a wheel rim, the V-shaped wheel spoke has two legs, and each of the two legs is provided with a connection part at a top portion of the leg, the connection parts are connectable with flanges at left and right sides of the hub.

As a further improvement, the connection parts are provided with external threads, the flanges at the left and right sides of the hub are provided with internal threads matching the external threads on the connection parts, and the connection parts are screwed into the internal threads on the flanges by the external threads during installation to achieve a fixed connection.

As a further improvement, the top of the connection part of each leg is provided with a fastening cap, the flanges at the left and right sides of the hub are correspondingly provided with third through holes, the connection parts of the two legs are fixedly connectable with the third through holes, the fastening cap of the connection part of each leg has an outer diameter greater than an inner diameter of the third through hole, after installation, a bottom surface of the fastening cap of the connection part of each leg is attached to an inner end surface of the third through hole.

As a further improvement, the bottom surface of the fastening cap of the connection part of each leg is provided with a metal sleeve, the metal sleeve is arranged around a periphery of the connection part, and during installation, an end of the metal sleeve away from the fastening cap passes through the third through hole.

As a further improvement, the fastening cap and the connection part are integrally formed as a single piece by carbon fiber material.

The present disclosure has the following advantages. According to the present disclosure, the conventional connection structure consisting of spokes and nipples has been abandoned, and bolts or fastening structures are used for connection. The two legs of the V-shaped spoke are respectively connected to the flanges at the left and right sides of the hub with bolts or fastening structures, such that the overall structure forms a stable triangle which greatly improves the strength and stiffness of the wheel. In addition, in some embodiments, the two legs of the V-shaped spoke and its corresponding fastening structure being integrally formed as a single piece by carbon fiber material can also greatly improve the tensile strength of the spokes and improve the installation efficiency. The position where each spoke is connected to the wheel rim only needs one bolt, such that the risk of fatigue fracture due to the angular deviation caused when drilling the holes on the wheel rim can be avoided. With this design, not only the strength and reliability of the spokes can be greatly improved, but also the strength requirements for the spoke holes of the rim can be greatly reduced, such that deformation and cracking of the wheel rim caused by insufficient strength of the spoke holes will not occur, and the overall weight of the wheel can also be reduced.

### BRIEF DESCRIPTION OF THE DRAWINGS

FIG. 1 is a schematic diagram of a V-shaped wheel spoke according to one embodiment of the present disclosure.

FIG. 2 is a side view of FIG. 1.

FIG. 3 is a schematic diagram showing some V-shaped wheel spokes according to the above embodiment of the present disclosure being installed on a wheel rim.

FIG. 4 is a schematic diagram showing the connection between the V-shaped wheel spoke and the wheel rim and the connection between the V-shaped wheel spoke and the hub of the wheel.

FIG. 5 is a schematic diagram of a V-shaped wheel spoke according to another embodiment of the present disclosure.

FIG. 6 is a side view of FIG. 5.

FIG. 7 is a schematic diagram showing the installation of the legs of some of the V-shaped wheel spokes shown in FIG. 5 at a left or right side of the hub of the wheel.

FIG. 8 is a schematic diagram of a V-shaped wheel spoke according to yet another embodiment of the present disclosure.

FIG. 9 is cross sectional view of part A shown in FIG. 8.

FIG. 10 is a side view of FIG. 8.

FIG. 11 is a schematic diagram showing the installation of the legs of some of the V-shaped wheel spokes shown in FIG. 8 at a left or right side of the hub of the wheel.

FIG. 12 is a schematic diagram of a V-shaped wheel spoke according to still another embodiment of the present disclosure.

FIG. 13 is a side view of FIG. 12.

FIG. 14 is a schematic diagram showing the installation of the legs of some of the V-shaped wheel spokes shown in FIG. 12 at a left or right side of the hub of the wheel.

The reference signs in the drawings are listed below: 1. V-shaped wheel spoke, 2. first through hole, 3. wheel rim, 4. bolt, 5. second through hole, 6. hub, 7. bolt; 1-1. connection part, 1-2. external threads, 1-3. internal threads, 1-4. fastening cap, 1-5. third through hole, 1-6. metal sleeve.

### DETAILED DESCRIPTION OF THE EMBODIMENTS

### Embodiment 1

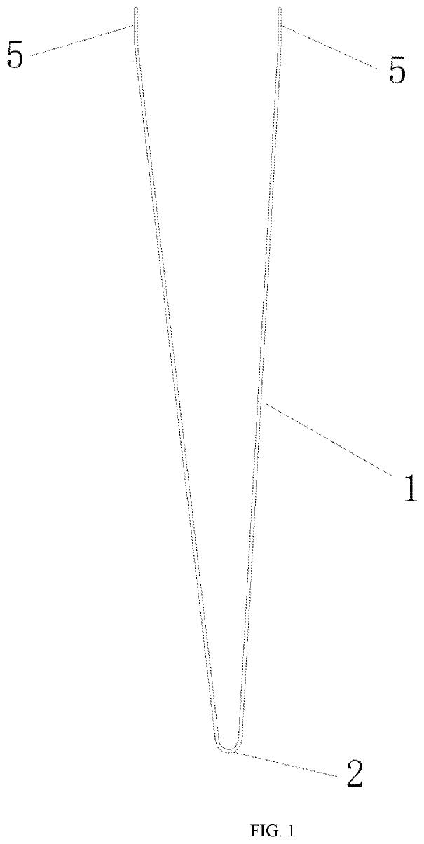

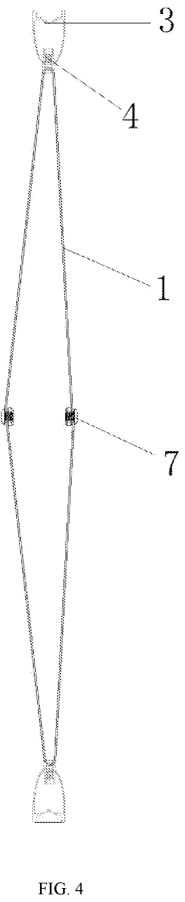

A V-shaped wheel spoke according to this embodiment of the present disclosure is shown in FIGS. 1-4. A bottom part of the V-shaped wheel spoke 1 is provided with a first through hole 2, the first through hole 2 is configured to place a bolt 4 for connecting the V-shaped wheel spoke 1 with a wheel rim 3, the V-shaped wheel spoke 1 has two legs, and each of the two legs is provided with a second through hole 5 at a top portion of the leg, the second through holes 5 are configured to place bolts 7 for connecting the V-shaped wheel spoke 1 with flanges at left and right sides of the hub 6. According to the present embodiment, the first through hole 2 at the bottom part of the V-shaped wheel spoke 1 has a diameter of 5 mm, and the second through hole 5 at the top portion of the legs of the V-shaped wheel spoke 1 has a diameter of 6 mm. According to the present disclosure, the V-shaped wheel spoke 1 may be made of carbon fiber material.

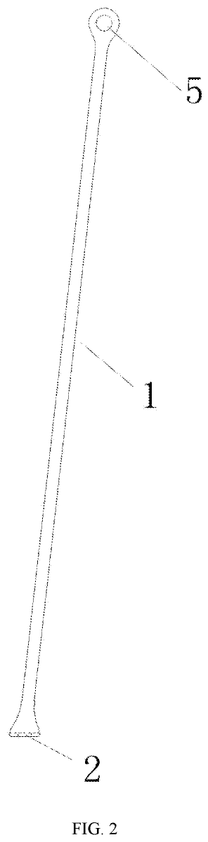

In the present embodiment, as shown in FIGS. 1-2, the V-shaped wheel spoke 1 has a height of 267.75 mm, a width between the top portion of the two legs of the V-shaped wheel spoke 1 is 52.8 mm, the top portion of the two legs of the V-shaped wheel spoke 1 has a round shape with an outer diameter of 11.5 mm. The first through hole 2 has a diameter of 5 mm, and the second through hole 5 has a diameter of 6 mm.

### Embodiment 2

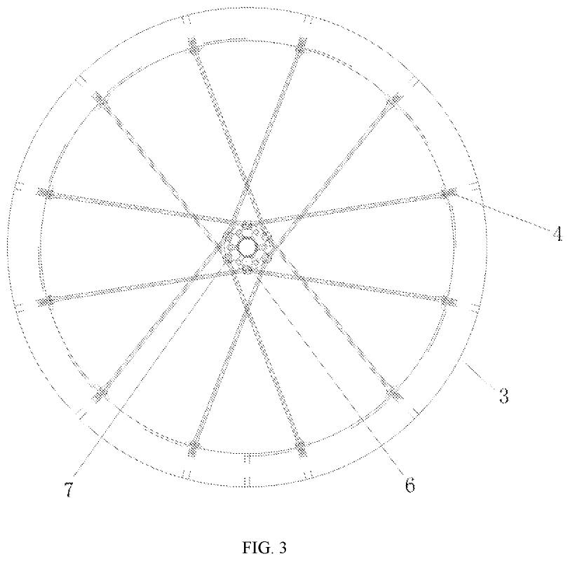

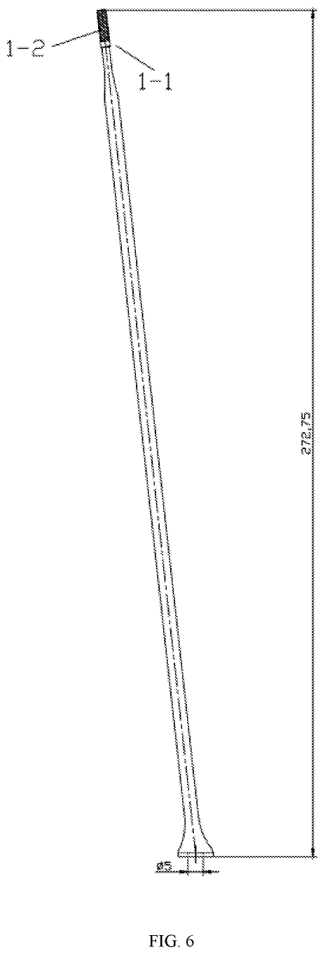

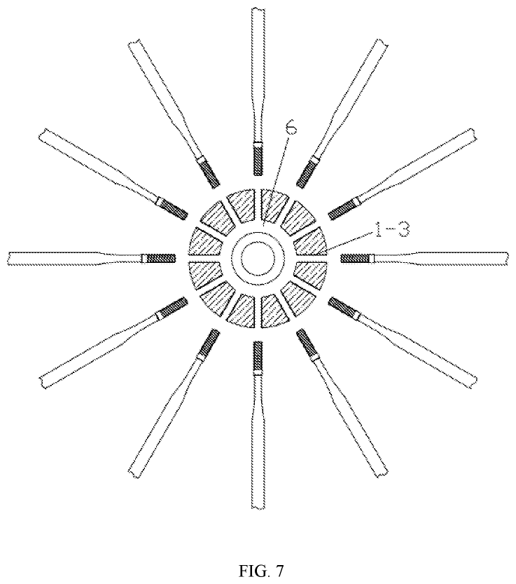

According to another aspect of the present disclosure, a V-shaped wheel spoke is provided. As shown in FIG. 3 and FIGS. 5-7, a bottom part of the V-shaped wheel spoke 1 is provided with a first through hole 2, the first through hole 2 is configured to place a bolt 4 for connecting the V-shaped wheel spoke 1 with a wheel rim 3, the V-shaped wheel spoke 1 has two legs, and each of the two legs is provided with a connection part 1-1 at a top portion of the leg, the connection parts 1-1 are connectable with flanges at left and right sides of the hub 6.

As a further improvement, the connection parts 1-1 are provided with external threads 1-2, the flanges at the left and right sides of the hub 6 are provided with internal threads 1-3 matching the external threads 1-2 on the connection parts 1-1, and the connection parts 1-1 are screwed into the internal threads 1-3 on the flanges by the external threads 1-2 during installation to achieve a fixed connection.

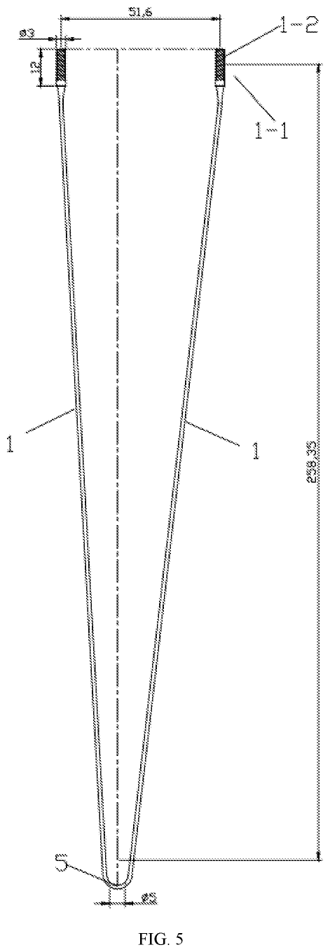

In the present embodiment, as shown in FIGS. 5-7, the V-shaped wheel spoke 1 has a height of 272.75 mm, a width between the top portion of the two legs of the V-shaped wheel spoke 1 is 51.6 mm, the connection part 1-1 at the top portion of the two legs of the V-shaped wheel spoke 1 has a columnar shape with an outer diameter of 3 mm and a height of 12 mm. The first through hole 2 has a diameter of 5 mm, and the V-shaped wheel spoke 1 may be made of carbon fiber material.

### Embodiment 3

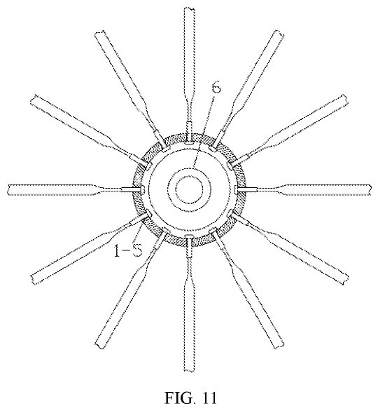

According to another aspect of the present disclosure, a V-shaped wheel spoke is provided. As shown in FIG. 3 and FIGS. 8-11, a bottom part of the V-shaped wheel spoke 1 is provided with a first through hole 2, the first through hole 2 is configured to place a bolt 4 for connecting the V-shaped wheel spoke 1 with a wheel rim 3, the V-shaped wheel spoke 1 has two legs, and each of the two legs is provided with a connection part 1-1 at a top portion of the leg, the connection parts 1-1 are connectable with flanges at left and right sides of the hub 6.

As a further improvement, the top of the connection part 1-1 of each leg is provided with a fastening cap 1-4, the flanges at the left and right sides of the hub 6 are correspondingly provided with third through holes 1-5, the connection parts 1-1 of the two legs are fixedly connectable with the third through holes 1-5, the fastening cap 1-4 of the connection part 1-1 of each leg has an outer diameter greater than an inner diameter of the third through hole 1-5, after installation, a bottom surface of the fastening cap 1-4 of the connection part 1-1 of each leg is attached to an inner end surface of the third through hole 1-5.

As a further improvement, the bottom surface of the fastening cap 1-4 of the connection part 1-1 of each leg is provided with a metal sleeve 1-6, the metal sleeve 1-6 is arranged around a periphery of the connection part 1-1, and during installation, an end of the metal sleeve 1-6 away from the fastening cap 1-4 passes through the third through hole 1-5.

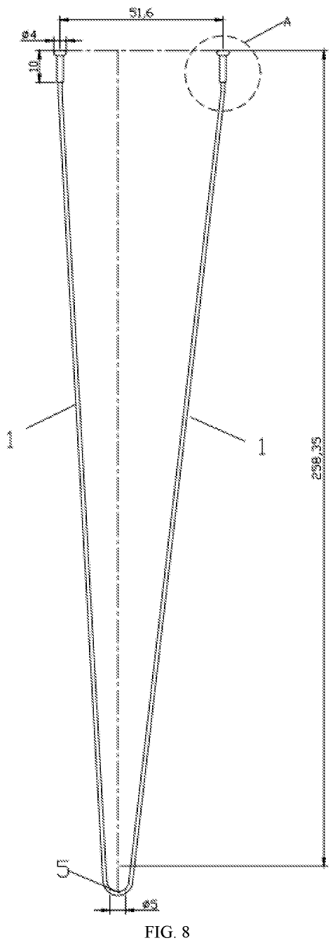

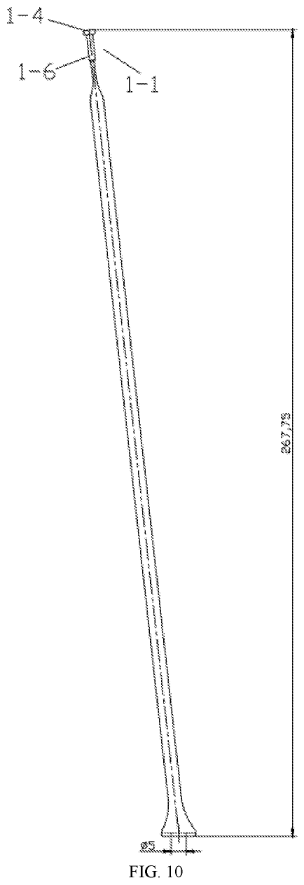

In the present embodiment, as shown in FIG. 8 and FIG. 10, the V-shaped wheel spoke 1 has a height of 267.75 mm, a width between the top portion of the two legs of the V-shaped wheel spoke 1 is 51.6 mm, a total vertical height of the metal sleeve 1-6 and the fastening cap 1-4 is 10 mm, an outer diameter of the fastening cap 1-4 is 4 mm, the first through hole 2 has a diameter of 5 mm, and the V-shaped wheel spoke 1 may be made of carbon fiber material.

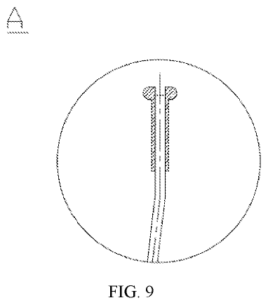

As a further improvement, as shown in FIG. 9, after installation, the fastening cap 1-4, metal sleeve 1-6 and leg of the V-shaped wheel spoke 1 has a hollow structure along the central axis direction.

### Embodiment 4

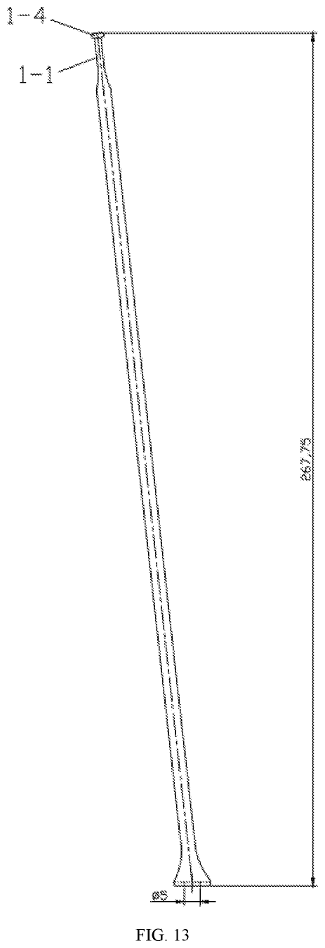

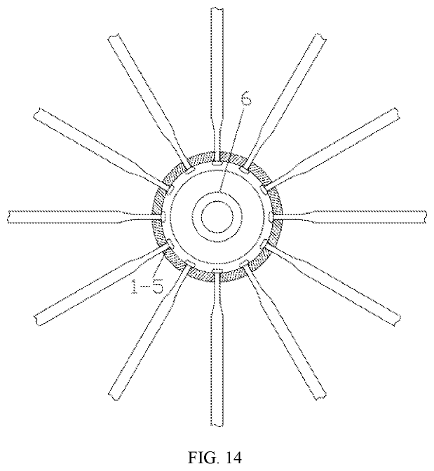

According to another aspect of the present disclosure, a V-shaped wheel spoke is provided. As shown in FIG. 3 and FIGS. 12-14, a bottom part of the V-shaped wheel spoke 1 is provided with a first through hole 2, the first through hole 2 is configured to place a bolt 4 for connecting the V-shaped wheel spoke 1 with a wheel rim 3, the V-shaped wheel spoke 1 has two legs, and each of the two legs is provided with a connection part 1-1 at a top portion of the leg, the connection parts 1-1 are connectable with flanges at left and right sides of the hub 6.

As a further improvement, the top of the connection part 1-1 of each leg is provided with a fastening cap 1-4, the flanges at the left and right sides of the hub 6 are correspondingly provided with third through holes 1-5, the connection parts 1-1 of the two legs are fixedly connectable with the third through holes 1-5, the fastening cap 1-4 of the connection part 1-1 of each leg has an outer diameter greater than an inner diameter of the third through hole 1-5, after installation, a bottom surface of the fastening cap 1-4 of the connection part 1-1 of each leg is attached to an inner end surface of the third through hole 1-5.

As a further improvement, the fastening cap 1-4 and the connection part 1-1 are integrally formed as a single piece by carbon fiber material.

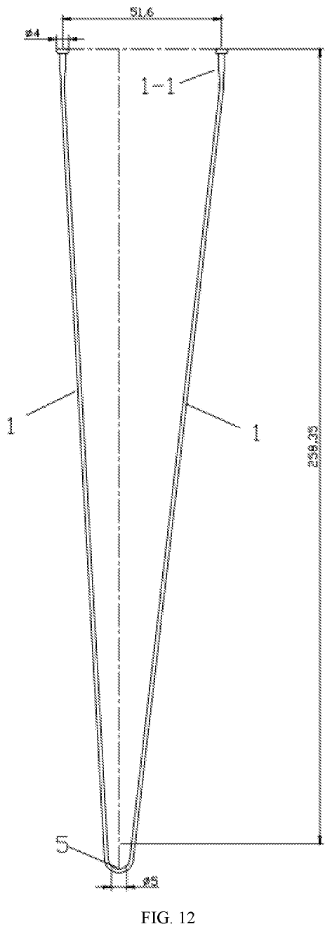

In the present embodiment, as shown in FIG. 12-14, the V-shaped wheel spoke 1 has a height of 267.75 mm, a width between the top portion of the two legs of the V-shaped wheel spoke 1 is 51.6 mm, an outer diameter of the fastening cap 1-4 is 4 mm, the first through hole 2 has a diameter of 5 mm, and the V-shaped wheel spoke 1 may be made of carbon fiber material.

The above description merely include preferable embodiments of the present disclosure which are used for illustrative purpose and not intended to restrict the scope of the present disclosure. For those of ordinary skill in the art, the present disclosure may have various changes and variations. All the changes, equivalent substitution and improvements made without departing from the spirit and principle of the present disclosure should be considered as falling within the protection scope of the present disclosure.

What is claimed is:

1. A V-shaped wheel spoke, wherein the wheel spoke has a V shape, a bottom part of the V-shaped wheel spoke is provided with a first through hole, the first through hole is configured to place a bolt for connecting the V-shaped wheel spoke with a wheel rim, the V-shaped wheel spoke has two legs, and each of the two legs is provided with a second through hole at a top portion of the leg, the second through holes are configured to place bolts for connecting the V-shaped wheel spoke with flanges at left and right sides of a hub.

2. The V-shaped wheel spoke according to claim 1, wherein the first through hole at the bottom part of the V-shaped wheel spoke has a diameter of 5 mm, and the second through hole at the top portion of the two legs of the V-shaped wheel spoke has a diameter of 6 mm.

3. The V-shaped wheel spoke according to claim 1, wherein the V-shaped wheel spoke is made of carbon fiber material.

4. A V-shaped wheel spoke, wherein the wheel spoke has a V shape, a bottom part of the V-shaped wheel spoke is provided with a first through hole, the first through hole is configured to place a bolt for connecting the V-shaped wheel spoke with a wheel rim, the V-shaped wheel spoke has two legs, and each of the two legs is provided with a connection part at a top portion of the leg, the connection parts are connectable with flanges at left and right sides of a hub.

5. The V-shaped wheel spoke according to claim 4, wherein the connection parts are provided with external threads, the flanges at the left and right sides of the hub are provided with internal threads matching the external threads on the connection parts, and the connection parts are screwed into the internal threads on the flanges by the external threads during installation to achieve a fixed connection.

6. The V-shaped wheel spoke according to claim 4, wherein the top of the connection part of each leg is provided with a fastening cap, the flanges at the left and right sides of the hub are correspondingly provided with third through holes, the connection parts of the two legs are fixedly connectable with the third through holes, the fastening cap of the connection part of each leg has an outer diameter greater than an inner diameter of the third through hole, after installation, a bottom surface of the fastening cap of the connection part of each leg is attached to an inner end surface of the third through hole.

7. The V-shaped wheel spoke according to claim 6, wherein the bottom surface of the fastening cap of the connection part of each leg is provided with a metal sleeve, the metal sleeve is arranged around a periphery of the connection part, and during installation, an end of the metal sleeve away from the fastening cap passes through the third through hole.

8. The V-shaped wheel spoke according to claim 6, wherein the fastening cap and the connection part are integrally formed as a single piece by carbon fiber material.
